(19) United States
(12) Patent Application Publication
(10) Pub. No.: US 2014/0043264 A1
(43) Pub. Date: Feb. 13, 2014

(54) TOUCHSCREEN AUTHENTICATION UNIT WITH DYNAMIC TOUCH LOCATIONS

(71) Applicant: SnowShoeFood, LLC., Madison, WI (US)

(72) Inventors: Erland S. Kelley, Madison, WI (US); Claus C. Moberg, Madison, WI (US); Matthew C. Luedke, Wheaton, IL (US); Isaac M. Ray, Madison, WI (US); Jami L. Morton, Middleton, WI (US)

(73) Assignee: SnowShoeFood, LLC., Madison, WI (US)

(21) Appl. No.: 13/961,387

(22) Filed: Aug. 7, 2013

Related U.S. Application Data
(60) Provisional application No. 61/680,598, filed on Aug. 7, 2012.
(60) Provisional application No. 61/680,601, filed on Aug. 7, 2012.

(51) Int. Cl. G06F 3/041

(52) U.S. Cl. CPC G06F 3/041
USPC 345/173

(57) ABSTRACT

An input device for a touchscreen provides simulated finger touches on the touchscreen that may dynamically change to produce a spatial and temporal pattern. In one embodiment mechanically constrained movable touch points may move into and out of contact with the screen while maintaining registration with respect to the other touch points within the dimension of the touch screen.

### CROSS-REFERENCE TO RELATED APPLICATIONS

This application claims the benefit of U.S. provisional application 61/680,598 filed Aug. 7, 2012 and U.S. provisional application 61/680,601 filed Aug. 7, 2012 both hereby incorporated by reference.

### BACKGROUND OF THE INVENTION

The present invention relates to a data interface for touchscreen devices and in particular to an interface providing a dynamic communication with a touchscreen.

Touchscreens provide a surface that may display text and images, for example, using a liquid crystal display and a backlight, while also providing electrical sensing of spatial location of a finger or stylus touch on that surface. Multitouch touchscreens that can simultaneously decode multiple touch points are currently common on “smart phones”, for example, the Apple corporation's iPhone or similar devices including devices capable of running Google's Android operating system.

Co-pending U.S. patent application Ser. No. 13/385,049 entitled: “Tool and Method for Authenticating Transactions”, filed Jan. 31, 2012, assigned to the same assignee as the present invention and hereby incorporated by reference, describes an interface device for communicating with a smart phone via the touchscreen, and useful, for example, to authenticate the presence of a user at a particular location. The interface device provides a conductive element having multiple raised contact mesas that may press against the surface of the touchscreen in the manner of human fingers. The spatial separation of the contact mesas describes a unique constellation that may be read by the smart phone to identify contact with that device and, by inference, location of the smart phone near where the device is located. In one embodiment, the device may be constructed of electrically conductive material such as aluminum and the contact mesas formed intricately therewith.

### SUMMARY OF THE INVENTION

The present invention provides an improvement on the above described interface device in which the “finger touches” generated by the contact mesas may be dynamically changed during application of the touch screen to the interface device. This ability to change the finger touch occurrences allows the device to be used with smart phones that have limited multitouch capability (for example, sensing only three multitouches as opposed to five multitouches) permitting greater security in the identification process, and may allow communication of dynamic data through the screen interface or a greater depth of information about a transaction via the stamp action.

Specifically, the present invention provides a data input device having a body providing a first face sized to be received proximate to an active area of a touchscreen of the type responding to a touch by a human finger or the like and providing electrical signals indicating a location of the touch on the active area. A set of touch elements are exposed at the first face for contact with the active area of the touchscreen when the first face is proximate to the active area of the touchscreen, the touch elements being dynamically operable to provide a time series of touches at different locations on the touchscreen detectable by the touchscreen.

It is thus a feature of at least one embodiment of the invention to provide a mechanism for the communication of arbitrarily complex data to an electronic device through its touchscreen. By providing a sequence of touches, the normal multitouch limitations of the touchscreen may be avoided.

The touch elements may be movably attached to the body to move into and out of contact with the touchscreen when the first face is received proximate to the active area of the touchscreen.

It is thus a feature of at least one embodiment of the invention to provide a simple mechanical method providing precise sequences of touches, difficult to render manually, and useful for authentication or other purpose.

The movement may be controlled by a pressing of a user of a mechanical operator on the body.

It is thus a feature of at least one embodiment of the invention to provide an extremely simple mechanism that may operate without a power source or electrical actuator.

The first face may provide a convex radius wherein the touch elements are exposed at different points on the first face to move into and out of contact with the touchscreen when the body is rolled across the touchscreen.

It is thus a feature of at least one embodiment of the invention to provide a simple mechanism that may produce a precise and predetermined time sequence difficult to produce by finger touches alone.

The touch elements may be attached to electrical switches connecting and disconnecting conductive touch elements from a reference voltage causing a touch on the active area of the touchscreen by the touch element when the touch element is electrically communicating with the reference voltage and not when the touch element is not electrically communicating with the reference voltage.

It is thus a feature of at least one embodiment of the invention provide a device that may produce a predetermined pattern of touches where the pattern is largely undetectable from the physical aspects of the device.

The data input device includes a time sequence circuit connecting and disconnecting the electrical switches from the reference voltage according to a predetermined time sequence.

It is thus a feature of at least one embodiment of the invention to permit arbitrarily complex time sequences of touches to be precisely produced on a simple handheld device for a variety of purposes.

The reference voltage is a reference potential of a human holding the body.

It is thus a feature of at least one embodiment of the invention to provide a wholly mobile device that does not require connection to a stationary power reference.

The time sequence circuit may provide an electronic memory and further includes a data port for receiving data from an external device into the electronic memory wherein the predetermined time sequence is determined by the data in the electronic memory.

It is thus a feature of at least one embodiment of the invention to provide simplified programming of the touch interface device of this kind.

These particular objects and advantages may apply to only some embodiments falling within the claims and thus do not define the scope of the invention.

### BRIEF DESCRIPTION OF THE DRAWINGS

FIG. 1 is a perspective view of a smart phone being held for placement against an interface device of the present invention, the latter holding multiple contact mesas;

FIG. 2 is a perspective view of a rear surface of the interface device showing two mechanical buttons that may be depressed during the contact operation of FIG. 1;

FIG. 3 is a fragmentary cross-section taken along line 3-3 of FIG. 2 showing a pressing of the buttons which moves contact mesas against the surface of a touchscreen of FIG. 1;

FIG. 4 is a side elevational view of an alternative embodiment of the present invention having an outwardly cylindrically convex surface so that a rolling action may sequentially bring contact mesas into contact with the touchscreen;

FIG. 5 is a plan view of a contact surface of the device of FIG. 4 showing sequential activation of touches by the contact mesas with the rolling motion of the authentication device;

FIG. 6 is a simplified block diagram of an electronic system dynamically changing touch locations by electrically connecting capacitive plates to a common ground by solid-state devices to provide electronically controllable touch activation;

FIG. 7 is a perspective view of a smart phone being held for placement against an interface device of the present invention mounted to a surface;

FIG. 8 is a fragmentary cross-section along line 8-8 showing the placement of an elastomeric pad on top of a conductive mesa for establishing a capacitive link to a touchscreen:

FIG. 9 is a figure similar to FIG. 8 showing alternative construction in which the elastomeric pad is placed in a depression on a conductive substrate;

FIG. 10 is a figure similar to FIG. 9 showing an elastomeric pad providing an island in a non-conductive elastomer forming a substantially continuous sheet on top of a conductive substrate;

FIG. 11 is a front perspective view of the interface device showing multiple conductive and nonconductive pads for obscuring the construction of the device; and

FIG. 12 is a figure similar to that of FIG. 11 showing a continuous elastomeric surface without visible demarcations between conductive and nonconductive areas.

### DETAILED DESCRIPTION OF THE PREFERRED EMBODIMENT

### Touchscreen Authentication Unit with Dynamic Touch Locations

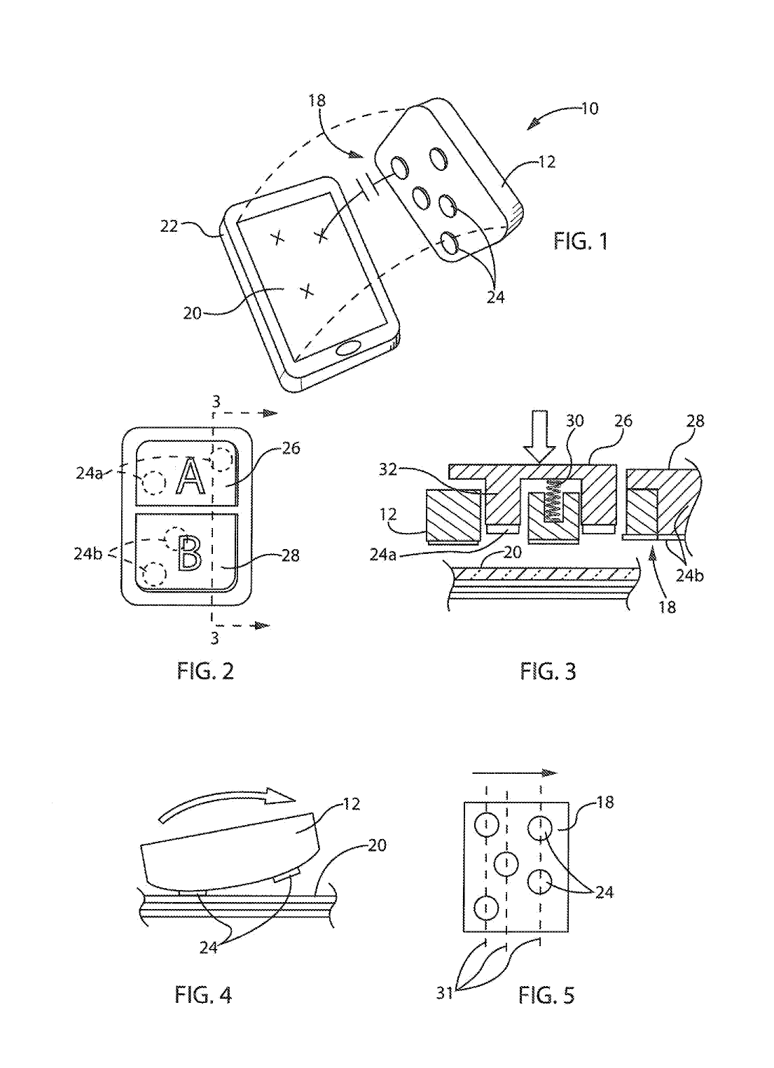

Referring now to FIG. 1, an interface device 10 of the present invention may provide for a body 12, for example a milled aluminum block or injection molded plastic housing, for example, using a conductive thermoplastic material to present a front face 18 having an area that may be received by a touchscreen 20 of a smart phone 22.

The front face 18 may have multiple projecting contact pads 24 that when placed in contact with the touchscreen 20 register as if they were finger touches. As described in the above-referenced co-pending application, each of these touches may be registered by the smart phone running an application program to uniquely identify the interface device 10 from the spatial separations and/or orientations of the contact pads 24. Generally, the contact pads 24 are electrically interconnected through the body 12 which provides a capacitive effect similar to that of finger touches at the contact pads 24 when the body 12 is held by a user as if it were attached to a low impedance voltage source, for example a ground reference.

Referring now to FIGS. 2 and 3, in one embodiment, a rear face of the interface device 10 may provide for two depressible buttons 26 and 28, with button 26 positioned above two contact pads 24a and button 28 positioned above two contact pads 24b, each of the contact pads 24a and 24b representing a subset of all of the contact pads 24. The buttons 26 and 28 communicate with their respective contact pads 24 to cause extension of the contact pads 24 from the front face 18 when the buttons 26 and 28 are depressed. The buttons 26 and 28 may be biased away from the body 12 when the buttons 26 or 28 are not pressed by a helical compression spring 30 or the like fitting between an inner surface of each button 26 or 28 and the rear surface of the conductive body. While the contact pads 24 may move freely toward and away from the touchscreen 20, the movement of the contact pads 24 is constrained with respect to the relative spatial separation in the plane of the touchscreen 20 so that precise touch point registrations may be maintained. The buttons 26 and 28 may connect the contact pads 24 by an extension sliding through channels in the body 12 to be in electrical communication with the body 12 or by conductive surface of the buttons 26 or 28.

Each of the conductive contact pads 24a and 24b may be, for example, a conductive elastomer such as graphite-impregnated silicone rubber and may be supported on front faces of conductive cylindrical bosses 32 passing through corresponding holes in the body 12 and extending between the buttons 26 and 28 and the contact pads 24a and 24b. When the buttons 26 and 28 are released, the conductive contact pads 24 are retracted beneath the front face 18 of the body 12 whereas, as noted, when the buttons 26 and 28 are depressed, the conductive contact pads 24 extend through the front face 18 to contact the touchscreen 20 and to be registered as a touch.

By sequentially pressing contact pads 24a and 24b, two different constellations of touches may be created, a first constellation composed of touches generated by pads 24a and a second constellation related to touches generated by pads 24b. Each of the sets of touches may be in number beneath a threshold multi-touch limit of the device and thus may be registered. That is, for a three touch multitouch touchscreen 20, the number of pads 24a may be three or less and the number of pads 24b may be three or less and the total number of pads, therefore, as many as six. The sequence of the touches may be combined to define a constellation or may be detected individually, the sequence being an order of the touches used as a dimension of the authentication process for additional security.

It will be appreciated that by insulating the buttons 26 and 28 from each other and from the remainder of the body 12 and forming the body 12 out of an insulating material, pressing the buttons 26 or 28 to establish a grounding electrical connection thereto may be sufficient to provide a touch through contact pads 24a and 24b respectively without necessarily moving the latter.

Referring now to FIGS. 4 and 5, in an alternative embodiment, the body 12 may be conductive and given a cylindrical convex front face 18 having pads 24 on the front face 18 positioned so that different contact pads 24 projecting therefrom may be selectively in contact with the touchscreen 20 as a user rolls the cylindrical body 12 across the touchscreen 20. In this case, different sets of contact pads 24 are defined by rolling engagement lines 31 defining lines of contact between the interface device 10 and the touchscreen 20. The convex front face 18 time sequences the contacts between the touchscreen 20 and the contact pads 24 creating a dynamically changing set of subsets of touches that may be used to provide an extra dimension of security and keep from overwhelming limited multitouch capability.

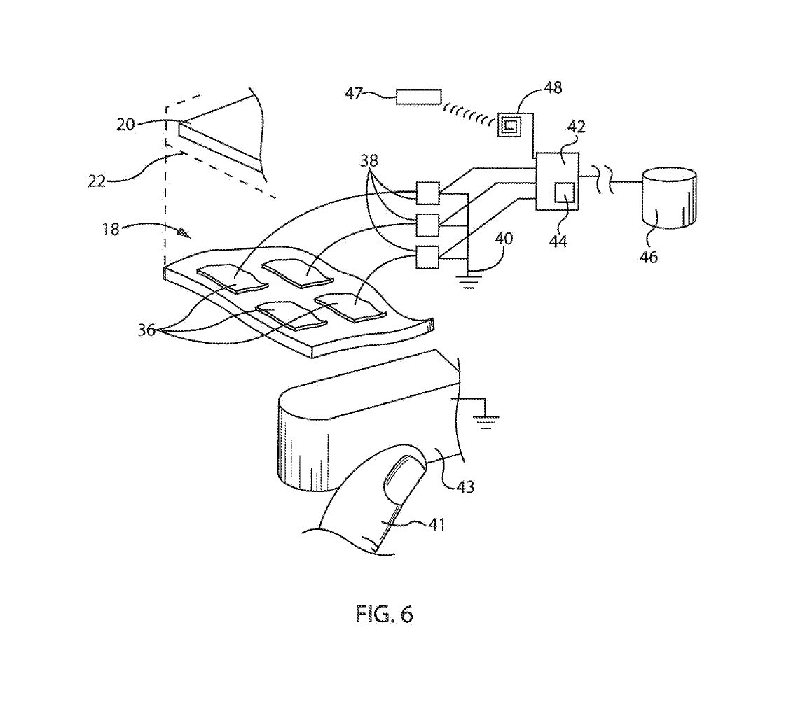

Referring now to FIG. 6, in yet an alternative embodiment, front face 18 may be covered with electrically independent conductive electrodes 36 arranged, for example, in a tile pattern, each electrode 36 having insufficient capacitance in itself to provide a triggering of a touch on the touchscreen 20. Each of the electrodes 36 may be connected to a solid-state switching device 38, for example a field effect transistor with a common ground 40, the latter which may, for example, communicate with a surface 43 that may touch a human operator to derive additional capacitance from inherit capacitive qualities of the human body 41 and/or the human body's capacitive relationship to the environment. The common ground 40 may be AC coupled to the switches 38, for example, through a capacitor or may be resistively coupled through a resistor or low-voltage conductor.

The solid-state switching devices 38 may be controlled by a microcontroller 42 executing a stored program held in a memory 44 to dynamically change the particular electrodes 36 connected to the common ground 40 and thus to change the registered touches to a touchscreen 20 positioned near the electrodes 36 over time providing the benefits described above. The system potentially allows modulation of the touches so as to convey data, for example, from a database 46 to the smart phone 22 of a dynamic quality. For example, in the context of an application providing a punch card for purchases, information can be transmitted through the changing touches communicating to the smart phone 22 a retained balance or number of punches remaining.

The microcontroller 42 in this regard may receive data from an external device 47 through an antenna 48, for example, in the form of communication used by radio frequency identification devices or other near field communication systems. This received data may be stored in the memory 44 and be used to communicate data from the memory or based on the data in the memory to the touchscreen 20. For example, the data in the memory 44 may hold credit information, password information or other changeable unique identifiers. It will be appreciated that the electrical keyboard (not shown) or the like may be used in lieu of antenna 48 for entering data used to control the electrodes 36.

### Touchscreen Authentication Unit with Elastomeric Surface

One embodiment of the invention provides an interface device in which the contact mesas are formed at least in part of a conductive elastomer. By placing an elastomeric material between the conductive body of aluminum or the like and the touch screen, consumer concerns about damage to the touchscreen are allayed without affecting the efficacy of the simulated touch. Elastomeric pads may also simplify manufacturing and provide an additional level of security against duplication of the interface device when that is important.

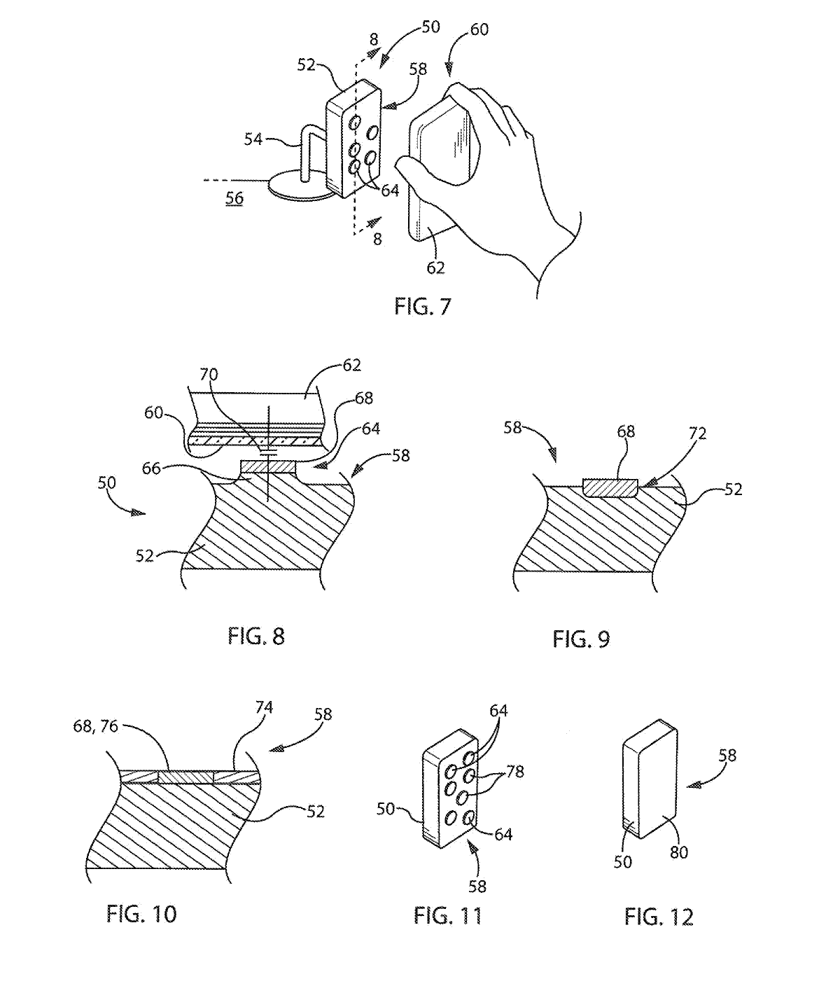

Referring now to FIG. 7, an interface device 50 of this embodiment may provide for a conductive body 52, for example a milled aluminum block, mounted on a stand 54, for example, attached to a fixture or other stationary surface 56 to present a front face 58 having an area that may be received by a touchscreen 60 of the smart phone 62.

The front face 58 may have multiple projecting contact pads 64 that when placed in contact with the touchscreen 60 register as if they were finger touches. As described in the above-referenced co-pending application, each of these touches may be registered by the smart phone running an application program to uniquely identify the interface device 50 by the spatial separations and orientations of the touches. Generally, the contact pads 64 are electrically interconnected through the conductive body 52 which provides a capacitive effect similar to that of finger touches at the contact pads 64.

Referring now to FIG. 8, each of the contact pads 64 may, for example, provide for outwardly extending mesa 66, for example, milled from the material of the conductive body 52 as an integral element and providing a generally raised, circular exposed face. On the circular face of each mesa 66 may be placed a disk-shaped conductive elastomeric pad 68, for example, formed of a graphite-impregnated silicone material. When a touchscreen 60 of the smart phone 62 is placed against the front face 58 of the interface device 50, the elastomeric pad 68 contacts the material of the touch screen 60 cushioning the contact and preventing abrasion or other damage. The conductive nature of the elastomeric pad 68 permits the desired capacitive coupling 70 between the conductive body 52 and a touchscreen 60 at an insulating surface of the touchscreen 60 to provide the desired simulation of a finger touch.

Referring now to FIG. 9, in an alternative embodiment the conductive elastomeric pad 68 may be increased somewhat in height and may fit within a depression 72 formed in the front face 58 in lieu of the mesas 66 described above. The depression ensures positive location of the conductive elastomeric pad 68 and eliminates the need for extensive material removal by milling, simplifying the manufacturing process.

Referring now to FIG. 10, in an alternative embodiment, the conductive body 52 may have a substantially planar upper front face 58 covered with a sheet of elastomeric material 74 with portions of that elastomeric material 74 providing conductive inclusions 76 providing effective conductive elastomeric pads 68. The inclusions 76 may, for example, be provided by die cutting appropriate apertures and inserting die cut conductive pads 68 into the apertures. The sheet of elastomeric material 74 will generally be nonconductive so as to not register touches outside the area of the conductive elastomeric pads 68,

Referring to FIG. 11, the front face 58 of the device 50 may include multiple visible pads 68 (providing touches) and pseudo-pads 78 (not providing touches), the former formed of a conductive elastomer and the latter formed of an insulating elastomer. The use of the pseudo-pads 78 obscures the particular pattern of touches produced on any given device 50.

Alternatively, as shown in FIG. 12, the front face 58 of the device 50 may provide for a substantially continuous elastomeric surface 80 with no visible demarcations, with the conductive inclusions 76 having a same color as the remainder of the elastomeric sheet material 74 with only the conductivity of the regions altered.

In some embodiments, the body 12, 52 will be sized to be easily held in one hand of an individual, for example, fitting within a volume having a longest dimension of six inches or less, a second longest dimension of four inches or less, and the thickness of less than two inches and having a weight of less than one quarter pound. As so supported, the block may be untethered to any fixed source of electrical power. In some embodiments, the body will have no connection to any source of electricity, or will have a contained battery, or will obtain induced electrical power from an external device without direct electrical connection. Generally the device will generate a set of different touch points far fewer than the total number of touch points resolvable by the touchscreen, for example, being less than 20 or less than 10. The device may provide for a mixture of fixed touch points and dynamically controllable touch points. A single electrically controllable touch point may provide for serial transmission of data to the touchscreen. Generally the body 12, 52 will be thicker than ⅛ of an inch and preferably greater than one quarter inch in thickness and thus easily differentiated from a card.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference, which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor.” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments arid combinations of elements of different embodiments as come within the scope of the following claims. All of the publications described herein, including patents and non-patent publications, are hereby incorporated herein by reference in their entireties.

What we claim is:

1. A data input device comprising:
a body providing a first face sized to be received proximate to an active area of a touchscreen of a type responding to a touch by a human finger or the like and providing electrical signals indicating a location of the touch on the active area; and
a set of touch elements exposed at the first face for contact with the active area of the touchscreen when the first face is proximate to the active area of the touchscreen, the touch elements being dynamically operable to provide a time series of touches at different locations on the touchscreen detectable by the touchscreen.

2. The data input device of claim 1 wherein the touch elements are movably attached to the body to move into and out of contact with the touchscreen when the first face is received proximate to the active area of the touchscreen.

3. The data input device of claim 1 wherein a movement of the touch elements is controlled by a pressing of a user of a mechanical operator on the body.

4. The data input device of claim 1 wherein the first face provides a convex radius and wherein the touch elements are exposed at different points on the first face to move into and out of contact with the touchscreen when the body is rolled across the touchscreen.

5. The data input device of claim 1 wherein the touch elements are attached to electrical switches connecting and disconnecting conductive touch elements from a reference voltage causing a touch on the active area of the touchscreen by the touch element when the touch element is electrically communicating with the reference voltage and not when the touch element is not electrically communicating with the reference voltage.

6. The data input device of claim 5 including a time sequence circuit connecting and disconnecting the electrical switches from the reference voltage according to a predetermined time sequence.

7. The data input device of claim 6 wherein the reference voltage is a reference potential of a human holding the body.

8. The data input device of claim 6 wherein the time sequence circuit provides an electronic memory and further includes a data port for receiving data from an external device into the electronic memory and wherein the predetermined time sequence is determined by the data in the electronic memory.

9. The data input device of claim 8 wherein the data port is a wireless data port.

10. The data input device of claim 1 wherein the time series of touches provides a time series of single touches at different locations.

11. The data input device of claim 1 wherein the time series of touches provides a time series of multiple touches at different locations where locations of the different locations change over time.

12. A method of inputting data through a touchscreen using a data input device comprising: (1) a body providing first face sized to be received proximate to an active area of a touchscreen of a type responding to a touch by a human finger or the like and providing electrical signals indicating a location of the touch on the active area; and (2) a set of touch elements exposed at the first face for contact with the active area of the touchscreen when the first face is proximate to the active area of the touchscreen, the touch elements being dynamically operable to provide a time series of touches at different locations on the touchscreen detectable by the touchscreen, the method comprising the steps of
(a) placing the first face against an active area of the touchscreen; and
(b) activating the touch elements to provide a time series of different touches at different locations on the touchscreen as detectable by the touchscreen.

13. The method of claim 12 wherein the touch elements are movably attached to the body to move into and out of contact with the touchscreen as controlled by a pressing of a user of a mechanical operator on the body and including the step of pressing the mechanical operator after step (a).

14. The method of claim 12 wherein the first face provides a convex radius and wherein the touch elements are exposed at different points on the first face to move into and out of contact with the touchscreen when the body is rolled across the touchscreen and including the step of rolling the body across the screen.

15. The method of claim 12 wherein the touch elements are attached to electrical switches connecting and disconnecting conductive touch elements from a reference voltage causing a touch on the active area of the touchscreen by the touch element when the touch element is electrically communicating with the reference voltage and not when the touch element is not electrically communicating with the reference voltage and including the step of sequentially activating the electrical switches.

16. The method of claim 15 wherein the time sequence circuit provides an electronic memory and further includes a data port for receiving data from an external device into the electronic memory and wherein the predetermined time sequence is determined by the data in the electronic memory and including the step of receiving data from an external device into the electronic memory and then outputting a predetermined time sequence based on the data in the electronic memory.
